(19) United States
(12) Patent Application Publication
(10) Pub. No.: US 2002/0068220 A1
(43) Pub. Date: Jun. 6, 2002

(54) Electrochemical cell and negative electrode therefor

(76) Inventors: Mark D. Wyler, Strongsville, OH (US); Thomas R. Hoesman, Bay Village, OH (US); M. Neal Golovin, Pepper Pike, OH (US)

Correspondence Address: ROBERT W WELSH, EVEREADY BATTERY COMPANY INC, 25225 DETROIT ROAD, P O BOX 450777, WESTLAKE, OH, 44145

(21) Appl. No.: 09/730,300

(22) Filed: Dec. 5, 2000

(51) Int. Cl. H01M 4/48; H01M 4/42; H01M 10/26; H01M 4/62; H01M 4/04

(52) U.S. Cl. 429/231; 429/212; 429/206; 252/182.1; 29/623.1

(57) ABSTRACT

An electrochemical cell is provided having a positive electrode, an alkaline electrolyte solution, a separator, and a negative electrode. The negative electrode comprises zinc powder, zinc oxide, gelling agent, and anolyte. The total zinc oxide is in the amount of 2.5 to 11 percent by weight of the negative electrode, The gelling agent is in an amount of 0.35 to 0.85 percent by weight of the negative electrode. The anolyte comprises potassium hydroxide in the amount of 30 to 37 percent by weight of the anolyte.

### BACKGROUND OF THE INVENTION

The present invention generally relates to alkaline electrochemical cells, and more particularly to an alkaline electrochemical cell having a viscous negative electrode (i.e., anode) containing zinc powder and other additives.

Alkaline electrochemical cells (i.e., batteries) generally include a positive electrode, commonly referred to as the cathode, and a negative electrode, commonly referred to as the anode, arranged in a steel can and separated by a separator. The anode, cathode, and separator simultaneously contact an alkaline electrolyte solution which typically includes potassium hydroxide (KOH). The cathode typically comprises manganese dioxide (MnO₂) as the electrochemically active material, and further includes graphite and other additives. The anode typically comprises zinc powder as the electrochemically active material. In addition, a gelling agent is also included in the anode. The zinc powder is typically suspended in the gelled electrolyte mixture to provide a gel-type anode.

Many commercially available electrochemical cells employ an anode having zinc powder generally in the amount of about 70 percent by weight of the anode. In addition, conventional commercially available cells typically employ a gelling agent in the amount of about 0.4 percent by weight of the anode. Conventional alkaline cells further employ an anode electrolyte solution, hereinafter referred to as anolyte, generally having a potassium hydroxide concentration of around 40 percent by weight of the anolyte, with the remainder of the anolyte made up substantially of water. Small quantities of other additives, such as sodium silicate, may also be included in the anolyte. Conventional cells having the aforementioned weight percentages have provided satisfactory service performance for many battery applications, but may not achieve optimal performance for certain applications.

Electrochemical cells are increasingly being employed in modern “high tech” devices which generally require intermittent high rate cell discharge. A goal in designing alkaline electrochemical cells is to increase the anode discharge performance to enhance service performance of the cell. It is therefore becoming increasingly desirable to provide for enhanced electrochemical cell service performance for use in high tech devices. It is also desirable to provide for an enhanced negative electrode that provides enhanced service performance at intermittent high rate discharge for use in high tech service applications.

### SUMMARY OF THE INVENTION

The present invention improves the service performance of an alkaline electrochemical cell for at least some applications, and particularly for high tech service applications. To achieve this and other advantages, the present invention provides for a substantially undischarged electrochemical cell having a positive electrode, a separator, a KOH solution, and a negative electrode. The negative electrode comprises zinc powder, solid zinc oxide, gelling agent, and an anolyte. The total zinc oxide is in the amount of 2.5 to 11 percent by weight of the negative electrode. According to one aspect of the present invention, the gelling agent is in the amount of 0.35 to 0.85 percent by weight of the negative electrode. According to another aspect of the present invention, the anolyte contains potassium hydroxide in the amount of 30 to 37 percent by weight of the anolyte.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a cutaway perspective view of an alkaline electrochemical cell employing an anode in accordance with the present invention;

FIG. 2 is a flow diagram illustrating a method of forming the anode and electrochemical cell according to an embodiment of the present invention; and

FIG. 3 is a bar graph comparing test results for a standard electrochemical cell formulation compared to electrochemical cells having anode additives according to the present invention.

### DEFINITIONS

For purposes of description herein, the following terms are defined. The term “alkaline electrolyte solution” is defined as the total quantity of electrolyte solution in the electrochemical cell once the cell has been fully assembled and equilibrated. The alkaline electrolyte solution includes potassium hydroxide, water, and additives. The term “KOH solution” is defined as the free electrolyte added to the electrochemical cell after the cell has been partially assembled. The KOH solution includes potassium hydroxide and water. The term “anolyte” is defined as the electrolyte combined with other anode ingredients, such as sodium silicate and zinc oxide which is then added to the anode dry ingredients such as zinc, gelling agent and indium hydroxide, prior to inserting the anode into the electrochemical cell. The term “catholyte” is defined as the electrolyte added to the cathode dry ingredients such as manganese dioxide and graphite, prior to manufacture of the cathode. The catholyte typically comprises 45 percent by weight potassium hydroxide.

### DETAILED DESCRIPTION OF THE PREFERRED EMBODIMENT

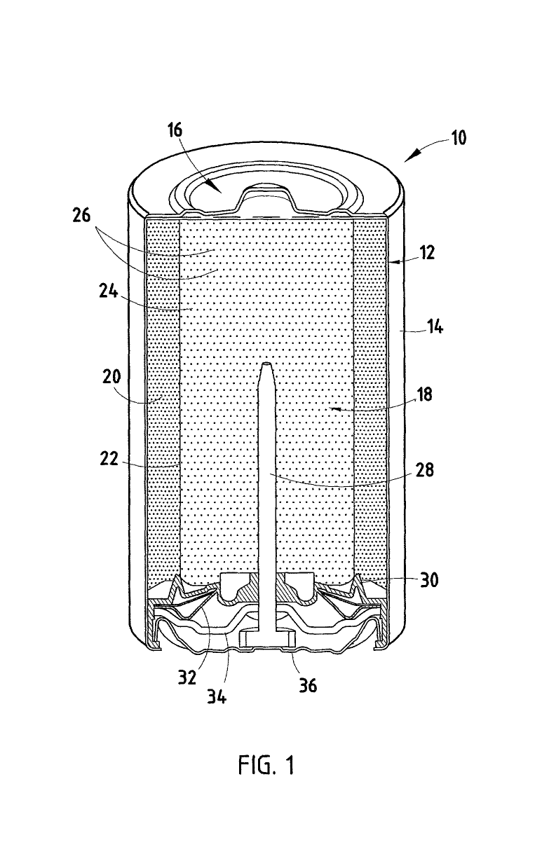

Referring to FIG. 1, a cutaway view of a cylindrical alkaline electrochemical cell 10 is shown employing zinc powder and various additives in a negative electrode (anode) according to the teachings of the present invention as explained herein. Alkaline electrochemical cell 10 generally includes a steel can 12 having cylindrical side walls, a closed top end, and an open bottom end. A metalized, plastic film label 14 is formed about the exterior surface of steel can 12, except for the ends of steel can 12. At the closed end of steel can 12 is a positive cover 16 preferably formed of plated steel. Film label 14 is formed over the peripheral edge of positive cover 16. The electrochemical cell 10 includes a positive electrode, referred to herein as the cathode 20, formed about the interior surface of steel can 12. According to one example, the cathode 20 may be formed of a mixture of manganese dioxide, graphite, an electrolyte solution (catholyte) containing potassium hydroxide (KOH) and water, and optional additives. A separator 22, which is preferably formed of a non-woven fabric that prevents migration of any solid particles in the cell, is disposed about the interior surface of cathode 20. A KOH solution 24, preferably formed of 37 percent potassium hydroxide, and water, is disposed in the steel can 12, preferably within the interior of separator 22.

Electrochemical cell 10 further includes a negative electrode, referred to herein as the anode 18. The anode 18 is disposed in an anode compartment formed within the separator 22, with the KOH solution 24, and in contact with a current collector 28, which may include a brass nail. The anode 18 may include a gel-type anode formed of zinc powder 26 suspended in the gelled electrolyte mixture, comprising gelling agent and anolyte. The zinc powder 26 may include BIA zinc having bismuth, indium, and aluminum additives alloyed therein, according to one example.

In addition, the current collector 28 is a brass nail with the head protruding through nylon seal 30. The nylon seal 30, located at the open end of steel can 12, prevents leakage of the active materials contained in steel can 12. Nylon seal 30 contacts a metal washer 32 and an inner cell cover 34, which is preferably formed of steel. A negative cover 36, which is preferably formed of plated steel, is disposed in contact with current collector 28 via a weld or pressure contact. Negative cover 36 is electrically insulated from steel can 12 via nylon seal 30. The collector 28, seal 30, washer 32, inner cover 34, and negative cover 36 generally make up a collector and seal assembly for sealing closed the open end of steel can 12. It is contemplated that other cathodes, separators, cans, and collector and seal assemblies may be employed in use in various types of alkaline electrochemical cells with the anode 18 of the present invention. Accordingly, the anode 18 of the present invention may be employed in any alkaline electrochemical cell.

According to the present invention, the anode 18 preferably employs zinc powder in the amount of 60 to 70 percent by weight of the anode, and more preferably in the amount of 62.5 to 67.5 percent by weight of the anode, and yet more preferably in the amount of approximately 65 percent by weight of the anode. In addition, the anode 18 includes solid zinc oxide powder, gelling agent, and anolyte. The gelling agent is a cross-linked polyacrylic acid that acts as a suspension medium to suspend the zinc powder. The gelling agent may include a cross-linking type branched polyacrylic acid, such as Carbopol® and, more particularly, Carbopol® 940(C940), which is manufactured and made available by B.F. Goodrich Specialty Chemicals. The gelling agent may alternately include carboxymethyl cellulose (CMC), polyacyrylamide, sodium polyacrylate, a granular preparation of cassava starch, or other agents that are stable in the alkaline electrolyte solution. The gelling agent is preferably present in the amount of 0.35 to 0.85 percent by weight of the anode, and more preferably in the range of 0.40 to 0.60 percent by weight of the anode, and yet more preferably of approximately 0.525 percent by weight of the anode. The anolyte preferably includes potassium hydroxide preferably in the range of 30 to 37 percent by weight of the anolyte, and more preferably in the range of 31 to 35 percent by weight of the anolyte, and yet more preferably in the amount of approximately 33 percent by weight of the anolyte. The remainder of the anolyte may include approximately 3 percent zinc oxide, 0.3 percent sodium silicate, and water. The total zinc oxide employed in anode 18, both as a solid and the quantity dissolved in the anolyte, preferably is in the range of 2.5 to 11 percent by weight of the anode, and is more preferably about 6 percent by weight of the anode.

As used herein, the term “total ZnO” specifically includes the solid ZnO, typically purchased in powder form, which is added to the anode's other dry ingredients during the anode manufacturing process as well as the ZnO that has been dissolved in the anolyte that forms a part of the anode. In cell embodiments in which no ZnO is dissolved in the anolyte prior to combining the anolyte with the anode's dry ingredients, then the term total ZnO would refer to the total amount of solid ZnO. Similarly, in cell embodiments in which no solid ZnO is added to the anode's other dry ingredients, then the term total ZnO would refer to the total amount of ZnO dissolved in the anolyte.

It should be appreciated that the present invention, in contrast to some prior cells, reduces the amount (in weight percentage) of zinc powder by replacing a quantity of the zinc powder with solid ZnO. The addition of solid zinc oxide in combination with an increase in the quantity of gelling agent and a reduction in the concentration of potassium hydroxide in the anolyte advantageously results in improved electrochemical cell performance, particularly for use in high tech service applications.

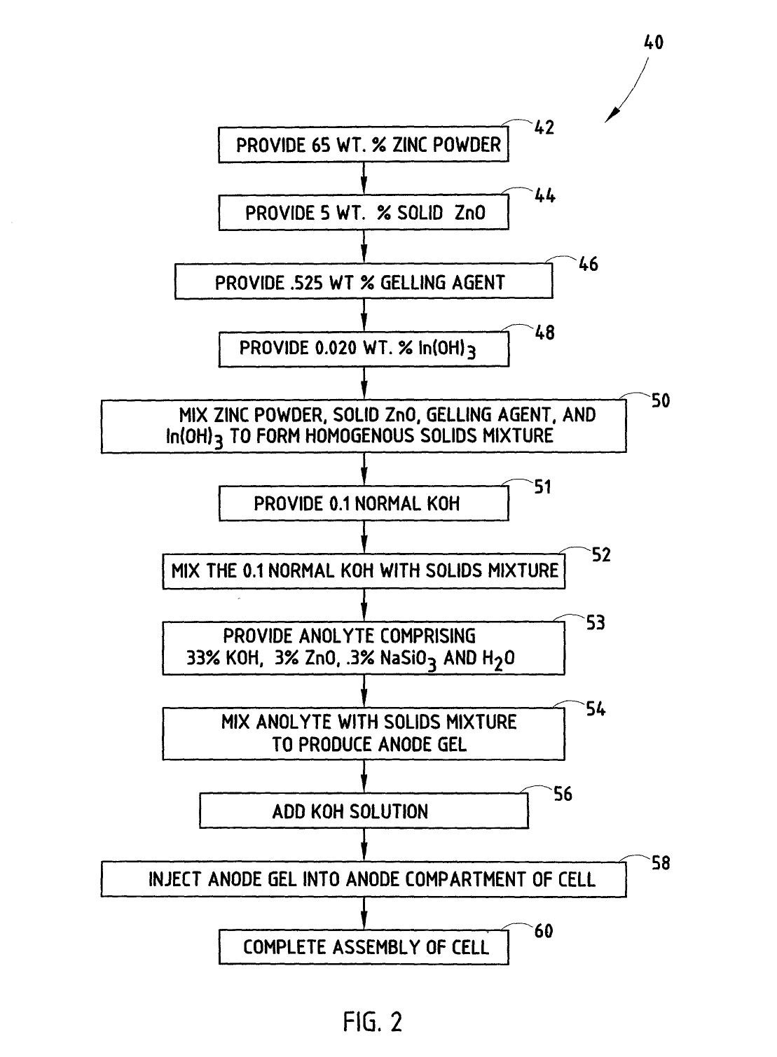

A process 40 of making the anode 18 and assembling an electrochemical cell will now be explained with reference to FIG. 2, according to one example. The process 40 includes providing zinc powder in the amount of 65 percent by weight of the anode in step 42, providing solid zinc oxide in the amount of 5 percent by weight of the anode in step 44, and providing gelling agent in the amount of 0.525 percent by weight of the anode in step 46. In addition, in step 48, indium hydroxide (In(OH)₃) in the amount of about 0.020 percent by weight of the anode is provided as a gas reducing additive. In step 50, the zinc powder, solid zinc oxide, gelling agent, and indium hydroxide are uniformly mixed together to form a homogenous solids mixture. In step 51, a quantity of 0.1 N KOH representing 1.17 percent based on the weight of the anode is provided. In step 52, the 0.1 N KOH is mixed with the solids mixture before proceeding to step 53.

Proceeding to step 53, process 40 includes providing anolyte containing about 33 percent potassium hydroxide, 3 percent zinc oxide, 0.3 percent sodium silicate, and the remainder being Water. The anolyte comprises about 28.390 weight percent of the anode. The anolyte is mixed with the solids mixture to provide an anode gel in step 54. A KOH solution of a sufficient amount is then added to the electrochemical cell in step 56. The amount of potassium hydroxide in the KOH solution is typically 30 to 45 percent by weight of the KOH solution. Preferably, the amount of potassium hydroxide in the KOH solution is 37 percent by weight of the KOH solution. The anode gel is then injected into the anode compartment of one or more electrochemical cells in step 58. It should be appreciated that the KOH solution may also be injected into the can following step 58. Thereafter, the assembly of the electrochemical cell is completed according to a well-known cell assembly technique which may include disposing a current collector in contact with the anode 18 and closing the open end of the steel can with a sealed closure.

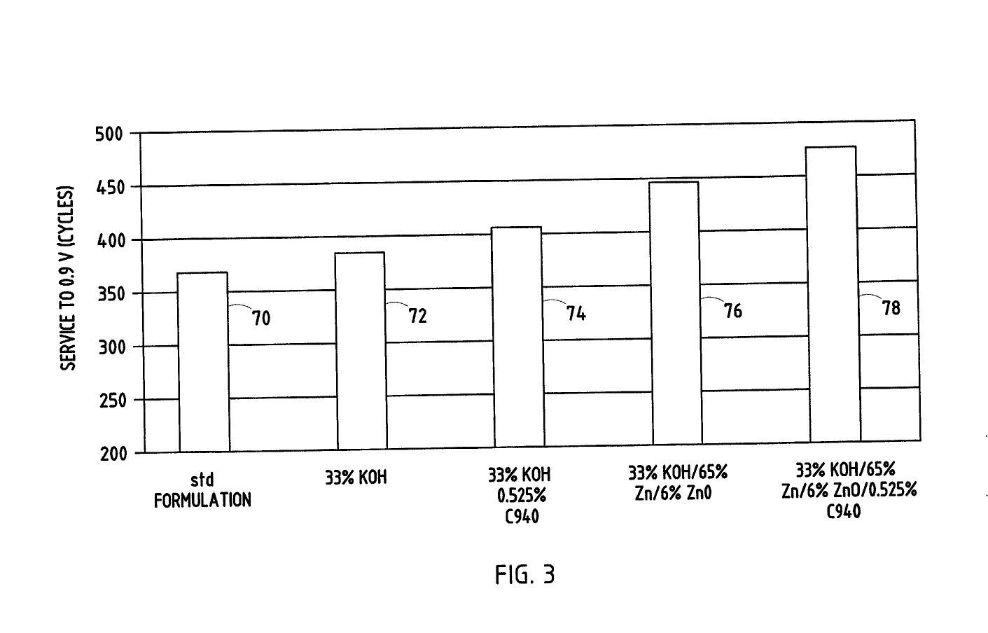

Referring to FIG. 3, the result of comparative testing is shown for an AA-size electrochemical cell containing a conventional anode compared with AA-size electrochemical cells containing anode additives according to the present invention. All cells tested had the same amount by weight of anode. The electrochemical cells tested employed an anode prepared using the aforementioned anode formulation shown in process 40. A high tech service test was employed in which the electrochemical cells were discharged at 1,000 milliamps for ten (10) seconds per minute, 60 minutes per hour, 24 hours per day, to determine how many ten second cycles occurred until the cell's closed circuit voltage dropped below 0.9 volts.

The service performance indicated by bar 70 indicates the number of cycles of service achieved with a cell having a conventional anode formulation. The conventional anode generating the test results shown in bar 70 contains 70 weight percent zinc powder, 0.420 weight percent gelling agent, 0.020 weight percent indium hydroxide, 1.170 weight percent 0.1 normal KOH solution, and 28.390 weight percent anolyte. The anolyte in the conventional anode tested included 37 percent KOH, 2.99 weight percent zinc oxide, 0.30 weight percent sodium silicate, with the remainder being water.

Bar 72 identifies the service performance achieved with a cell similar to the conventional anode formulation resulting in bar 70, with the exception that the anolyte has a reduced concentration of potassium hydroxide in the amount of 33 weight percent of the anolyte. Bar 74 indicates the service performance of a similar cell having an anode formulation with reduced concentration of potassium hydroxide of 33 weight percent of the anolyte, a gelling agent in the amount of 0.525 weight percent of the anode, and 28.285 weight percent anolyte. Bar 76 indicates the service performance achieved with a similar cell having an anode formulation with reduced concentration of potassium hydroxide of 33 weight percent of the anolyte, zinc powder in the amount of 65 weight percent of the anode, and total ZnO in the amount of 6 weight percent of the anode.

Bar 78 indicates the service performance achieved with a similar cell having an anode formulation, according to the preferred embodiment of the present invention, with zinc powder in the amount of 65 weight percent of the anode, total zinc oxide in the amount of 6 weight percent of the anode, 0.525 weight percent gelling agent, and 28.285 weight percent anolyte. All of these weight percentages are based on the weight of the anode.

The anolyte employed with the cell exhibiting the test results in bars 72, 74, 76 and 78 included 33 percent KOH, 2.99 weight percent zinc oxide, 0.30 weight percent sodium silicate, with the remainder being water. These weight percentages are based on the weight of the anolyte. The service performance indicated by bar 76, achieved with 33 weight percent potassium hydroxide in the anolyte, 65 weight percent zinc powder, and ZnO in the amount of 6 weight percent of the anode, is significantly greater than the conventional service performance indicated by bar 70. Further, utilizing 0.525 weight percent gelling agent further enhances the service performance as shown by bar 78. It should also be appreciated that cells incorporating anodes with total ZnO in the amount of 6 weight percent of the anode and with 0.525 weight percent gelling agent will also achieve enhanced service performance over conventional cells.

Accordingly, the anode formulation employing a reduced quantity of zinc powder, an increased quantity of gelling agent, and the addition of solid zinc oxide advantageously provides for enhanced service performance for electrochemical cells, particularly for high tech service applications.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. A substantially undischarged electrochemical cell comprising:
a positive electrode; and
a negative electrode containing zinc, zinc oxide in the amount of 2.5 to 11 percent by weight of the negative electrode, a gelling agent in the amount of 0.35 to 0.85 percent by weight of the negative electrode, and an anolyte.

2. The electrochemical cell as defined in claim 1, wherein said anolyte comprises potassium hydroxide in the range of 30 to 37 percent by weight of the anolyte.

3. The electrochemical cell as defined in claim 2, wherein said potassium hydroxide is in the amount of 31 to 35 percent by weight of the anolyte.

4. The electrochemical cell as defined in claim 3, wherein said potassium hydroxide is in the amount of about 33 percent by weight of the anolyte.

5. The electrochemical cell as defined in claim 1, wherein said zinc is in the amount of 60 to 70 percent by weight of the negative electrode.

6. The electrochemical cell as defined in claim 5, wherein said zinc is in the amount of 62.5 to 67.5 percent by weight of the negative electrode.

7. The electrochemical cell as defined in claim 6, wherein said zinc is in the amount of about 65 percent by weight of the negative electrode.

8. The electrochemical cell as defined in claim 1, wherein said zinc oxide is in the amount of about 6 percent by weight of the negative electrode.

9. The electrochemical cell as defined in claim 1, wherein said gelling agent is in the amount of 0.40 to 0.60 percent by weight of the negative electrode.

10. The electrochemical cell as defined in claim 8, wherein said gelling agent is in the amount of about 0.525 percent by weight of the negative electrode.

11. The electrochemical cell as defined in claim 1, wherein said gelling agent comprises cross-linked polyacrylic acid.

12. A substantially undischarged alkaline electrochemical cell comprising:
a positive electrode;
a KOH solution including potassium hydroxide in the range of 30 to 45 percent by weight of the KOH solution; and
a negative electrode containing zinc, a gelling agent, and zinc oxide in the range of 2.5 to 11 percent by weight of the negative electrode, and an anolyte.

13. The electrochemical cell as defined in claim 12, wherein said gelling agent is in the amount of 0.35 to 0.85 percent by weight of the negative electrode.

14. The electrochemical cell as defined in claim 13, wherein said gelling agent is in the amount of 0.40 to 0.60 percent by weight of the negative electrode.

15. The electrochemical cell as defined in claim 14, wherein said gelling agent is in the amount of about 0.525 percent by weight of the negative electrode.

16. The electrochemical cell as defined in claim 12, wherein said zinc is in the amount of 60 to 70 percent by weight of the negative electrode.

17. The electrochemical cell as defined in claim 16, wherein said zinc is in the amount of 62.5 to 67.5 percent by weight of the negative electrode.

18. The electrochemical cell as defined in claim 17, wherein said zinc is in the amount of about 65 percent by weight of the negative electrode.

19. The electrochemical cell as defined in claim 12, wherein said zinc oxide is in the amount of about 5 percent by weight of the negative electrode.

20. The electrochemical cell as defined in claim 12, wherein said anolyte comprises 31 to 35 percent by weight potassium hydroxide.

21. The electrochemical cell as defined in claim 20, wherein said anolyte comprises about 33 percent by weight potassium hydroxide.

22. A substantially undischarged electrochemical cell comprising:
a positive electrode;
a KOH solution including potassium hydroxide in the range of 30 to 45 percent by weight of the electrolyte; and
a negative electrode containing zinc in the amount of 60 to 70 percent by weight of the negative electrode, zinc oxide in the amount of 2.5 to 11 percent by weight of the negative electrode, and a gelling agent in the amount of 0.35 to 0.85 percent by weight of the negative electrode, and an anolyte.

23. The electrochemical cell as defined in claim 22, wherein said zinc is in the amount of 62.5 to 67.5 percent by weight of the negative electrode.

24. The electrochemical cell as defined in claim 23, wherein said zinc is in the amount of about 65 percent by weight of the negative electrode, and said zinc oxide is in the amount of about 6 percent by weight of the negative electrode.

25. The electrochemical cell as defined in claim 22, wherein said anolyte comprises 31 to 35 percent by weight potassium hydroxide.

26. The electrochemical cell as defined in claim 25, wherein said anolyte comprises about 33 percent by weight potassium hydroxide.

27. The electrochemical cell as defined in claim 22, wherein said gelling agent is in the amount of 0.40 to 0.60 percent by weight of the negative electrode.

28. The electrochemical cell as defined in claim 27, wherein said gelling agent is in the amount of about 0.525 percent by weight of the negative electrode.

29. The electrochemical cell as defined in claim 22, wherein said gelling agent comprises crosslinked polyacrylic acid.

30. A negative electrode for an alkaline electrochemical cell, said negative electrode comprising:
zinc;
zinc oxide in the amount of 2.5 to 11 percent by weight of the negative electrode;
a gelling agent in the amount of 0.35 to 0.85 percent by weight of the negative electrode; and
an anolyte.

31. The negative electrode as defined in claim 30, wherein said anolyte comprises potassium hydroxide in the range of 30 to 37 weight percent of the anolyte.

32. The negative electrode as defined in claim 30, wherein said anolyte comprises potassium hydroxide in the amount of 31 to 35 percent by weight of the anolyte.

33. The negative electrode as defined in claim 32, wherein said anolyte comprises potassium hydroxide in the amount of about 33 percent by weight of the anolyte.

34. The negative electrode as defined in claim 30, wherein said zinc is in the amount of 60 to 70 percent by weight of the negative electrode.

35. The negative electrode as defined in claim 34, wherein said zinc is in the amount of 62.5 to 67.5 percent by weight of the negative electrode.

36. The negative electrode as defined in claim 30, wherein said zinc is in the amount of approximately 65 percent by weight of the negative electrode, and said zinc oxide is in the amount of approximately 6 percent by weight of the negative electrode.

37. The negative electrode as defined in claim 30, wherein said gelling agent comprises cross-linked polyacrylic acid.

38. A negative electrode for an alkaline electrochemical cell, said negative electrode comprising:
zinc;
zinc oxide in the amount of 2.5 to 11 percent by weight of the negative electrode;
a gelling agent; and
an anolyte including potassium hydroxide in the amount of 30 to 37 percent by weight of the anolyte.

39. The negative electrode as defined in claim 38, wherein said anolyte includes potassium hydroxide in the amount of 31 to 35 percent by weight of the anolyte.

40. The negative electrode as defined in claim 39, wherein said anolyte contains potassium hydroxide in the amount of about 33 percent by weight of the anolyte.

41. The negative electrode as defined in claim 38, wherein said gelling agent is in the amount of 0.35 to 0.85 percent by weight of the negative electrode.

42. The negative electrode as defined in claim 41, wherein said gelling agent is in the amount of 0.40 to 0.60 percent by weight of the negative electrode.

43. The negative electrode as defined in claim 41, wherein said gelling agent comprises crosslinked polyacrylic acid.

44. The negative electrode as defined in claim 38, wherein said zinc is in the amount of 60 to 70 percent by weight of the negative electrode.

45. The negative electrode as defined in claim 38, wherein said zinc is in the amount of approximately 65 percent by weight of the negative electrode, and zinc oxide is in the amount of approximately 6 percent by weight of the negative electrode.

46. A process for manufacturing a negative electrode for an alkaline electrochemical cell, said process comprising the steps of:
providing zinc;
providing zinc oxide in the amount of 2.5 to 11.0 percent by weight of the negative electrode;
providing a gelling agent in the amount of 0.35 to 0.85 percent by weight of the negative electrode;
providing an anolyte including potassium hydroxide in the amount of 30 to 37 percent by weight of the anolyte; and
mixing the zinc, zinc oxide, gelling agent, and anolyte to form a negative electrode.

47. The process as defined in claim 46, wherein said anolyte comprises potassium hydroxide in the amount of 31 to 35 percent by weight of the anolyte.

48. The process as defined in claim 47, wherein said anolyte comprises potassium hydroxide in the amount of 33 percent by weight of the anolyte.

49. The process as defined in claim 46, wherein said zinc is in the amount of 60 to 70 percent by weight of the negative electrode.

50. The process as defined in claim 49, wherein said zinc is in the amount of 62.5 to 67.5 percent by weight of the negative electrode.

51. The process as defined in claim 46, wherein said zinc is in the amount of approximately 65 percent by weight of the negative electrode, and said zinc oxide is in the amount of approximately 6 percent by weight of the negative electrode.

52. The process as defined in claim 46, wherein said gelling agent comprises cross-linked polyacrylic acid.

53. The process as defined in claim 46, wherein said gelling agent is in the amount of 0.40 to 0.60 percent by weight of the negative electrode.

54. The process as defined in claim 46 further comprising the steps of disposing said negative electrode in a container to form an alkaline electrochemical cell.
